(19) United States
(12) Patent Application Publication
(10) Pub. No.: US 2007/0288487 A1
(43) Pub. Date: Dec. 13, 2007

(54) Method and system for access control to consumer electronics devices in a network

(75) Inventors: Yu Song, Pleasanton, CA (US); Doreen Cheng, San Jose, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/809,016

(22) Filed: May 30, 2007

Related U.S. Application Data
(60) Provisional application No. 60/812,577, filed on Jun. 8, 2006.
(60) Provisional application No. 60/812,459, filed on Jun. 8, 2006.

(51) Int. Cl. G06F 17/30

(52) U.S. Cl. 707/10

(57) ABSTRACT

A method and system for access control to resources comprising consumer electronics (CE) devices in a local network such as a home network, is provided. Controlling access involves maintaining an access list in the network, wherein the access list includes information for controlling access to one or more resources in the network; receiving an access request for access to a resource in the network; and controlling access to the resource based on the access list. The resources can be one or more devices providing services and/or content. The one more devices can be one or more non-legacy devices and/or one or more legacy devices.

### RELATED APPLICATIONS

This application claims the benefit under 35 U.S.C. 119(e) of U.S. Provisional Patent Application Ser. No. 60/812,577, filed on Jun. 8, 2006, incorporated herein by reference, and U.S. Provisional Patent Application Ser. No. 60/812,459, filed Jun. 8, 2006, incorporated herein by reference.

### FIELD OF THE INVENTION

The present invention relates to networks and in particular, to accessing devices in networks.

### BACKGROUND OF THE INVENTION

With the proliferation of computer networks, many electronics devices such as consumer electronics (CE) devices, are being connected to networks, and can be remotely accessible via external networks such as the Internet. This has made control of remote access to such devices and their content more important.

Access control has been a topic of research since multi-user computer systems became more available. The main purpose of access control is to allow an owner of a device to have control over who can access the device, at what time, and which services and content provided by the device can be accessed.

Traditional desktop computer systems (PCs) and workstation systems implement simple access control methods. In such systems, each file is associated with three rights for at least three groups: an “owner”, a “group” and an “other”. The three rights are “read”, “write” and “execute”. Only the owner of the file can change the access rights for the other. For example, the owner can specify that anyone can read the file, but cannot write the file. Such access control methods, however, are not adequate for access control in CE devices in the Internet era as such methods only specify read, write and execute rights. There, is therefore, a need to allow a network/device owner more control over how a device, services and content can be accessed.

With the increasing popularity of Internet Protocol (IP) networks, IP filtering has become an integrated part of access control for many enterprises and local area networks such as home networks. Such IP filtering, blocks data packets from certain devices whose IP addresses are specified in a deny list. For example, a network administrator can specify that any packets from an IP address in the 104.22.0.0/16 domain cannot be passed into the network. IP filtering technologies work in the IP layer and require deep understanding of the IP and Internet technologies to be effective. In addition, IP filtering is essentially an all-or-nothing approach, wherein a packet from a certain IP address is either blocked or allowed, no matter what payload the packet carries.

Standards, such as the Universal Plug and Play (UPnP) forum, have proposed access control mechanisms that attempt to address access control for CE devices in networks. Such standards, however, do not address access for legacy devices that do not have an access control mechanism built into them. Many networks, such as home networks, are mixed environments including legacy devices and non-legacy devices (i.e., modern devices). Many non-legacy devices are capable of understanding access control, while legacy devices are not. There is, therefore, a need for a method and system for access control to networks which address the above shortcomings. There is also a need for such a method and system to provide access control in networks including legacy and non-legacy devices.

### BRIEF SUMMARY OF THE INVENTION

The present invention provides a method and system for access control to resources in networks. In one embodiment, controlling access to a local network including one or more resources comprising consumer electronics (CE) devices includes: maintaining an access list in the network, wherein the access list includes information for controlling access to one or more resources in the network; receiving an access request for access to a resource in the network; and controlling access to the resource based on the access list. The resources comprise one or more devices providing services and/or content. The one more devices comprise one or more non-legacy devices and/or one or more legacy devices.

A service client is implemented in a remote device external to the network, and connects to the network via a communication link. Controlling access to the resource based on the access list further includes consulting the access list to determine if the request is allowed, and if the request is allowed, then providing access for the requested resource.

Connecting the service client to the network via a communication link further includes the service client sending the request to an interface device in the network using a connection service access protocol, and controlling access to the resource based on the access list further comprises consulting the access list to determine if the request is allowed, and if the request is allowed, then translating the request from the connection service access protocol to a local service access protocol for the requested resource.

Controlling access further includes generating a response to the request and sending the response to the service client. Sending a response to the service client further includes translating the response from the service access protocol of the device to the connection service access protocol of the service client, before sending the response to the service client via the interface and the communication link.

In another embodiment, the request identifies a device capable of providing the resource, such that the step of controlling access to the resource based on the access list further comprises consulting a local access list in said device identified in the request in order to determine if the request is allowed.

In another embodiment, controlling access to the resource based on the access list further comprises providing access to the resource, generating a response to the request, and filtering the response based on the access list. The response is filtered by selectively removing content from the response based on the access list. The communication link can be the Internet, and connecting the service client to the network includes establishing a secured connection over the communication link.

These and other features, aspects and advantages of the present invention will become understood with reference to the following description, appended claims and accompanying figures.

### BRIEF DESCRIPTION OF THE DRAWINGS

FIG. 1 shows a functional block diagram of an example network implementing access control, according to an embodiment of the present invention.

FIG. 2 shows an example architecture for logical modules implemented in the network of FIG. 1, for providing access control, according to an embodiment of the present invention.

FIG. 3 shows a flowchart of an example process for centralized access control during a service access session, according to the present invention.

FIG. 4 shows another example of an access control process including response filtering, according to the present invention.

FIG. 5 shows another example architecture for providing access control in a network, according to the present invention

FIG. 6 shows another example access control architecture according to the present invention, wherein a remote service client accesses a network through a secured link.

### DETAILED DESCRIPTION OF THE INVENTION

The present invention provides a method and system for access control to resources in networks. In one embodiment, the present invention provides access control that allows a local area network to specify access control for resources including devices and content/services provided by such devices in the network. Such devices include non-legacy devices that are inherently capable of understanding access control, and legacy devices. The access control mechanism provides a user access to devices/services/content in the network, wherein access control is implemented at a messaging level. As such, the present invention is suitable for network environments including legacy devices that do not have access control capability and non-legacy devices that understand access control.

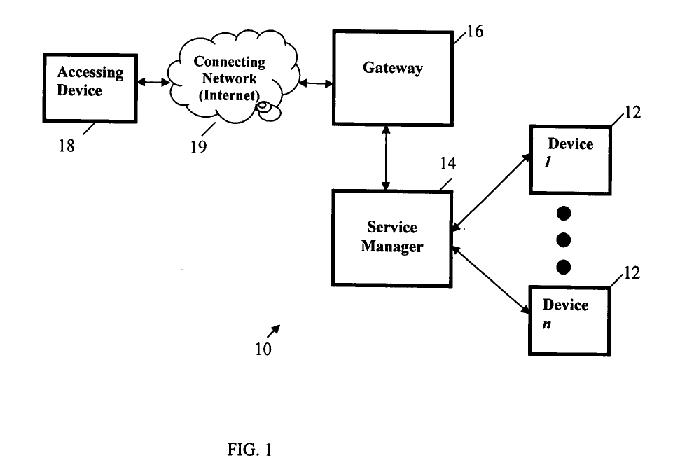

FIG. 1 shows an example network that is implemented as a local area network, such as a home network 10 including resources such as one or more devices 12 (e.g., n CE devices) providing content, services, etc., a service manager 14, and an interface device such as a gateway 16 that connects the network 10 to an accessing device 18 (external to the network 10) via a connecting network such as the Internet 19. One or more devices 12 provide services and/or content. Examples of such devices include DTV's, smart phones, mobile phones, set-top boxes, PC's, printers, scanners, cameras, radios, DVD/CD players, music players and PDAs. Although FIG. 1 shows a home network, those skilled in the art will recognize that the present invention is useful with other types of networks. As such, the present invention is not limited to a local area network (LAN) or a home network. For example, the network 10 can comprise a virtual private network (VPN). The devices 12 include non-legacy devices, and other devices including legacy devices. Non-legacy devices are not treated any differently than legacy devices.

The accessing device 18 attempts to access a device 12 in the network 10 via the Internet 19 and control the device 12 and/or to access services/content provided by the device 12. The gateway 16 manages communication between the device 12 and device 18 on the Internet 19. The service manager 14 provides mechanisms for controlling access to devices and contents/services in the network 10. The service manager 14 can be implemented in a host device in the network 10, and exports services provided by the devices 12 to the Internet 19, and controls access via the Internet 19 to the devices 12 and their services/contents. The host can be a PC or a CE device such as a DTV, a set-top box, or a home media server, in the network 10.

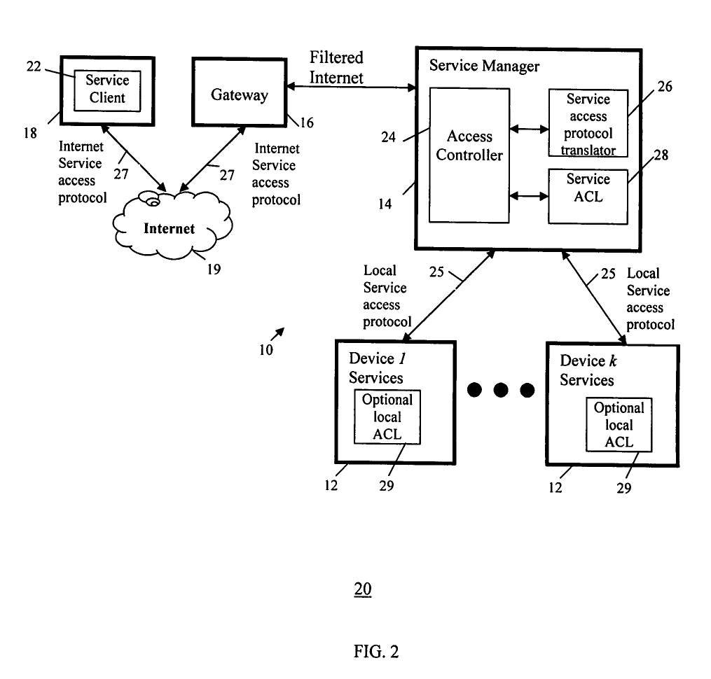

FIG. 2 shows an architecture 20 for logical modules (e.g., software, firmware, circuit) implemented in the network 10 and the accessing device 18, for providing access control according to an embodiment of the present invention. The accessing device 18 includes a logical module comprising a service client 22. The service manager 14 includes three logical modules comprising an access controller 24, a service access protocol translator 26 and a service access control list (ACL) 28. The ACL 28 indicates information for determining if, and how, a network resource (e.g., a device, content, service in the network) can be accessed by a service client such as a remote/external device. Each device 12 can optionally maintain a local ACL 29. In one example, an ACL includes access rights on a file (e.g., read, write, execute) for groups, users, etc. Other examples are possible.

The service client 22 sends one or more request messages to access and/or control one or more devices 12 and/or the services/contents provided by one or more devices 12 in the network 10. In one implementation, the service client is an application on the remote device that uses the services in the local network. For example, a media player on a remote cell phone to play video from a home network must make a remote request to the home network to fetch the video. The gateway 16 implements a firewall function at a networking level and optionally at an application level, and routes information traffic and requests/responses between the devices 12 and the Internet 19.

The access controller 24 provides service-level and content-level access control for the devices 12.

The service access protocol translator 26 translates service-level access protocols between the service client 22 (e.g., translates HTTP to Jini), the Internet service access protocol 27 providing service access on the Internet (e.g., HTTP), and each particular device 12 as the local service access protocol 25. Two or more of the devices 12 may use different local service access protocols 25. For example, the access protocol 25 for a UPnP device is different from the access protocol for a Jini device; and both are different from the protocol for accessing a legacy device. Similarly service client(s) 22 may choose to use various Internet service access protocols 27, e.g., SOAP, REST, in accessing each device 12.

Services provided by one or more participating devices 12 (one or more devices 1 to n) include, e.g., computational services, I/O services, content access and/or rendering services and user interface (UI) functions. In addition, a device 12 may choose to either manage access control locally or to depend on the service manager 14 to control access on its behalf. In the latter case, such a device includes a local ACL 29 therein to allow the device to control access to itself based on the information in its ACL 29.

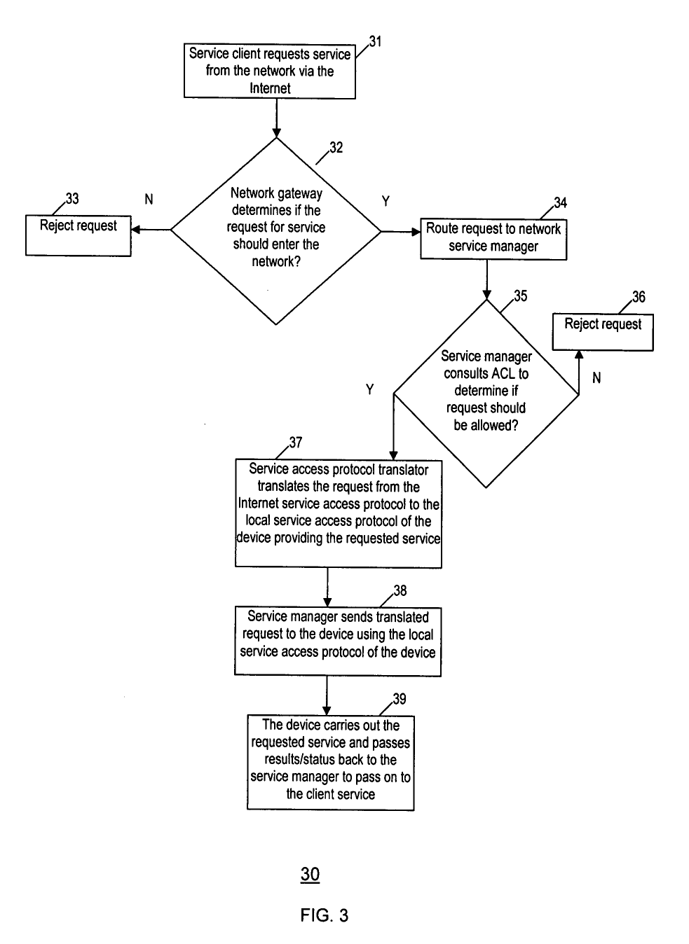

Access control in the network 10 can be centralized, distributed, or a hybrid of both. In the centralized configuration shown in FIG. 2, the ACL 28 resides on the component where the access controller 24 of the service manager 14 resides. Access control for all services and contents provided by the devices 12 is conducted by the access controller 24. FIG. 3 shows a flowchart of an example process 30 for centralized access control during a service access session, according to the present invention. The session is initiated by, e.g., the service client 22 running (FIG. 2) remotely over the Internet 19 for requesting access to the network 10. The access control process 30 includes the following steps:
Step 31: The service client requests a service from the network using a message via a connection service access protocol such as an Internet service access protocol, wherein the service can include accessing network devices, accessing network contents, accessing network software components, setting up or modifying the states of network devices and/or services, etc. The gateway looks up the source IP address of the message; if the source IP is in a “block” list, it drops the message, otherwise, it allows the message to pass through.
Step 32: When such a request message arrives at the network gateway, the gateway examines the request message and determines whether the message should be allowed to enter the network based on the security policies used by the gateway 16. If the request message is not allowed, the process proceeds to step 33, otherwise the process proceeds to step 34.
Step 33: The gateway ignores the request, or returns a rejection message to the service client. End.
Step 34: The gateway routes the message as a trusted service-requesting message to the network service manager (i.e., the access controller).
Step 35: Upon receiving the service request message, the service manager consults with the service ACL to determine whether the request should be allowed to proceed. If the request should not be allowed, the process proceeds to step 36, otherwise the process proceeds to step 37.
Step 36: The service manager can choose to ignore the request or to send an error message to the service client indicating that the request has been declined, and the process terminates.
Step 37: When the request is allowed, the service manager works with the service access protocol translator to translate the request message from the Internet service access protocol to a local service access protocol used by a device that provides the requested service in the network.
Step 38: The service manager then sends the resulting request message to that device using the local service access protocol for that device.
Step 39: The device carries out the requested service and passes a response message, including any output result and/or execution status, back to the service manager using the local service access protocol of the device. The service manager then sends a message containing the result/status to the network gateway which in turn sends that message to the service client over the Internet.

The steps 32, 33 and 34 in FIG. 3 are performed by the gateway 16. According to steps 35, 36, 37, 38 in FIG. 3, the access controller 24 provides service-level and content-level access control for the devices 12.

In addition to providing access control for service requests by the service client 22, upon receiving results/status responses from a network device 12, the service manager 14 can filter such responses for content before sending them to the service client 22. Such filtering of responses allows control for access to not only the services in the network 10, but also to content therein.

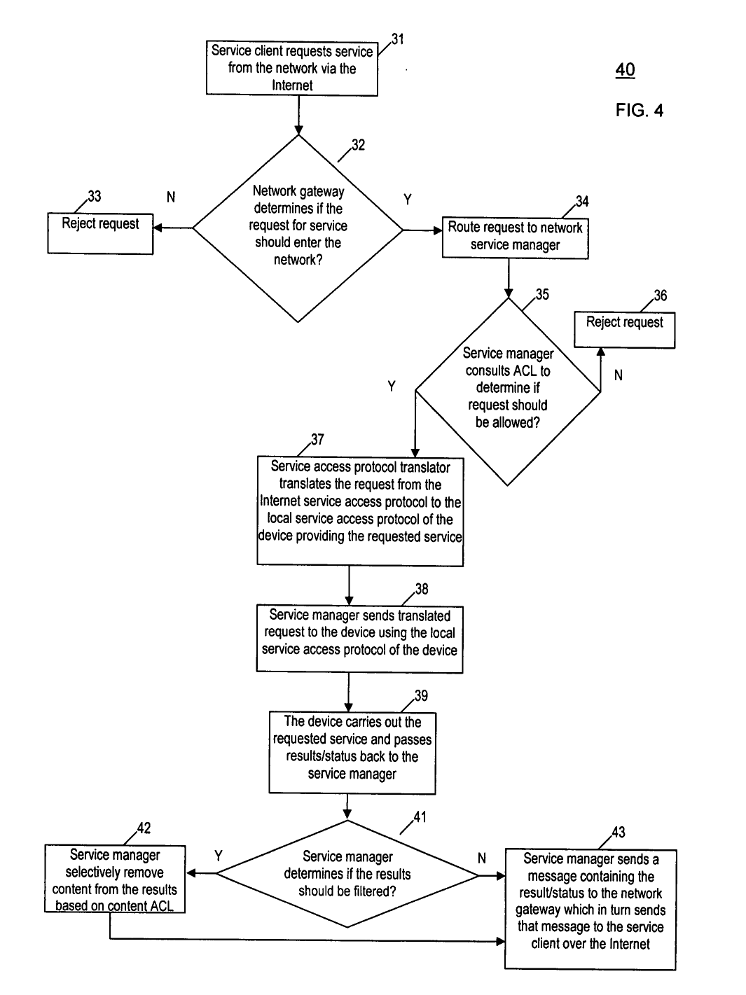

FIG. 4 shows another example access control process 40 according to the present invention, which is a variation of the process 30 in FIG. 3. In the access control process 40, in addition to the policies for services, access control policies (such as the ACL described above) describe that certain files/contents in one or more devices 12 should not be visible to a service client 22 when it attempts to browse/search files/contents on a device 12. As such, after receiving a response message from a device 12, including a result and/or status information in response to a request by the service client 22, in step 41 the service manager 14 (i.e., the service access controller 24) determines if based on the ACL in the service manager and/or the ACL in a device, the response message should be subject to filtering. If not, then in step 43, the service manager 14 sends a response message containing the result/status to the network gateway 16 which in turn sends that response message to the service client 22 over the Internet 19. Specifically, the access controller 24 of the service manager 14 uses the service access protocol translator 26 to translate the response message from the service access protocol 25 of the device to a service response message according to the Internet service access protocol 27 used by the requesting service client 22. The service manager 14 then sends the formed messaged to the gateway 16 which in turn sends that message to the service client 22 over the Internet 19.

If in step 41, filtering is indicated, then in step 42 the service manager 14 examines the result in the response message based on the ACL, and filters out content in the response message that based on the ACL should not be visible to the service client 22. The process then proceeds to step 43, described above.

In a distributed access control configuration, each device 12 manages its own (local) ACL 29 and decides: (1) whether to allow a service request to proceed locally, and (2) whether to filter a service response. The steps involved are similar to steps 35, 36 and 38 in FIG. 3 except the allowed message is not sent to the device (the message arrives on the device already). Instead, the service on the device is invoked on acceptance of the message.

Although in the examples herein the CE devices are shown as part of a local network such as a home network, the present invention is also useful in cases where a CE device is not connected to a home network, and may include the access manager therein.

In this case the access controller of the service manager only performs necessary protocol translations (using the service access protocol translator), before forwarding an access request from the service client to a device 12. In a hybrid configuration, the access controller manages the ACL 28 and access control for one or more devices 12, while other devices 12 manage their own local ACL 29 and access control. As those skilled in the art will recognize, the processes 30 and 40 can be simply modified for the distributed configuration and the hybrid configuration.

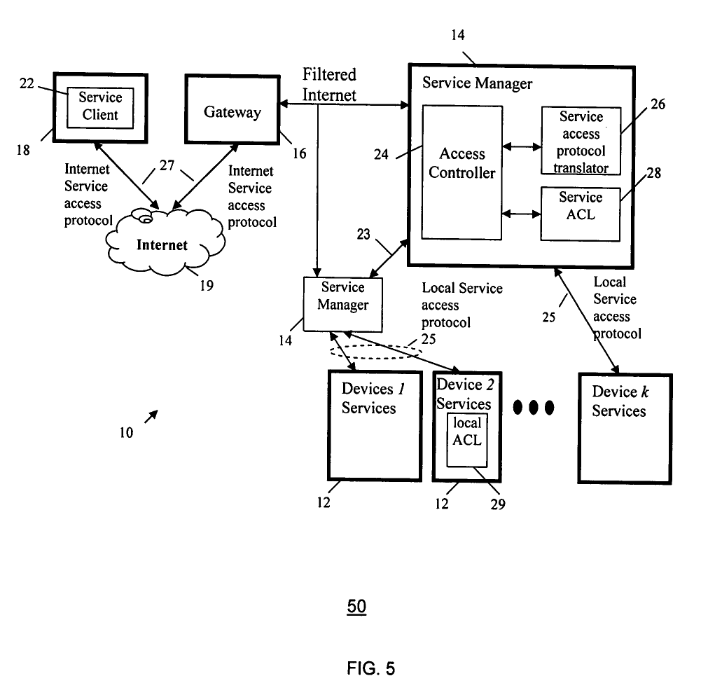

Other implementations according to the present invention are possible, such as the example architecture 50 in FIG. 5. In this case, more than one service manager 14 manages access control for one or more devices 12, in a coordinated fashion using messages 23, and zero or more devices 12 manage their service accesses locally (e.g., Device 2 Services in FIG. 5). The coordination can be based on existing coordination protocols such as a token ring.

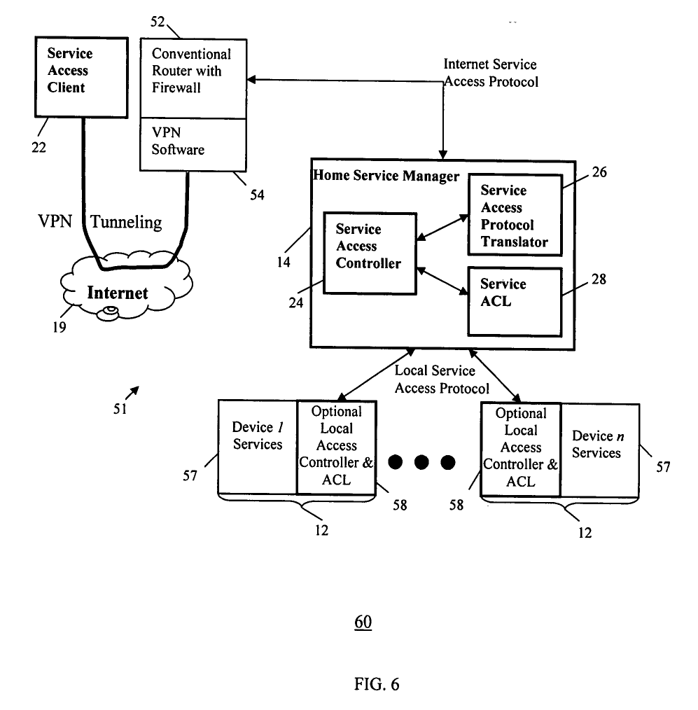

FIG. 6 shows another architecture 60 according to another embodiment of the present invention, wherein a remote service client 22 accesses a network 51 through a secured link such as a VPN. The network 51 includes a gateway 52, a communication component 54 (e.g., VPN software implementing VPN tunneling), a service manager 14 and devices 12. The service access client 22 has the capability to set up a secured connection with the gateway 52 and to access services/content/devices in the network 51 through the secured connection. The communication component 54 manages the secured connections and the message traffic passing through the secured connection, including: passing the incoming messages from the secured connection to a firewall in the gateway 52, wherein the messages are in a form expected by the firewall, and further passing outgoing messages from the firewall in the gateway 52 by placing the messages into proper form and sending them out of the network 10 through a secured connection via the Internet 19. A device service 57 can be a UPnP AVTransport Service that provides transportation of audio and video streaming. The optional Local Access Controller and ACL 58 can be a UPnP security service that provide access control to content. The steps implemented for FIG. 6 are similar to that for FIG. 5, except that before the service client sends the request, it must establish a VPN channel with the router.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method for controlling access to a local network including one or more resources comprising consumer electronics devices, comprising the steps of:
maintaining an access list in the local network, wherein the access list includes information for controlling access to one or more resources in the local network;
receiving an access request for access to a resource in the local network; and
controlling access to the resource based on the access list.

2. The method of claim 1 wherein the one or more resources comprises one or more consumer electronics (CE) devices in a home network.

3. The method of claim 1 wherein the one more devices comprise:
one or more non-legacy devices and/or one or more legacy devices.

4. The method of claim 1 wherein the access list indicates if, and how, a network resource can be accessed by a service client.

5. The method of claim 4 wherein the service client is implemented in a remote device external to the network.

6. The method of claim 5 wherein the network comprises a local area network (LAN).

7. The method of claim 5 wherein the network comprises a virtual private network (VPN).

8. The method of claim 5 further comprising the step of:
the service client connecting to the network via a communication link.

9. The method of claim 8 wherein the step of controlling access to the resource based on the access list further comprises the steps of: consulting the access list to determine if the request is allowed, and if the request is allowed, then providing access for the requested resource.

10. The method of claim 9 wherein:
the service client connecting to the network via a communication link further includes the service client sending the request to an interface device in the network using a connection service access protocol; and
the step of controlling access to the resource based on the access list further comprises the steps of: consulting the access list to determine if the request is allowed, and if the request is allowed, then translating the request from the connection service access protocol to a local service access protocol for the requested resource.

11. The method of claim 10 wherein the step of controlling access to the resource based on the access list further comprises the step of: sending the translated request to a device in the network for accessing the resource, using said local service access protocol.

12. The method of claim 11 further comprising the step of receiving a response from the device for accessing the resource, and sending the response to a service client.

13. The method of claim 12 wherein the step of sending the response to the service client further includes the steps of:
translating the response from the service access protocol of the device to the connection service access protocol of the service client before sending the response to the service client via the interface and the communication link.

14. The method of claim 9 wherein the step of controlling access to the resource based on the access list further comprises the step of consulting a centralized access list to determine if the request is allowed.

15. The method of claim 9 wherein the request identifies a device capable of providing the resource, such that the step of controlling access to the resource based on the access list further comprises consulting a local access list in said device identified in the request in order to determine if the request is allowed.

16. The method of claim 9 wherein the step of controlling access to the resource based on the access list further comprises the steps of:
providing access to the resource;
generating a response to the request; and
filtering the response based on the access list.

17. The method of claim 16 wherein filtering the response further includes the steps of selectively removing content from the response based on the access list.

18. The method of claim 8 wherein the communication link comprises the Internet.

19. The method of claim 1 wherein the step of connecting the service client to the network includes establishing a secured connection over the communication link.

20. An apparatus for controlling access to a local network including one or more resources comprising consumer electronics (CE) devices, including:
a service manager configured for maintaining an access list in the local network, wherein the access list includes information for controlling access to one or more resources in the local network; and
the service manager including an access controller configured for controlling access to the resource based on the access list upon receiving an access request for access to a resource in the local network.

21. The apparatus of claim 20 wherein the one or more resources comprises one or more consumer electronics devices, and the local network comprises a home network.

22. The apparatus of claim 20 wherein the one more devices comprise: one or more non-legacy devices and/or one or more legacy devices.

23. The apparatus of claim 20 wherein the access list indicates if, and how, a network resource can be accessed by a service client.

24. The apparatus of claim 23 wherein the service client is implemented in a remote device external to the network.

25. The apparatus of claim 24 wherein the network comprises a local area network (LAN).

26. The apparatus of claim 24 wherein the network comprises a virtual private network (VPN).

27. The apparatus of claim 24 wherein the access manager is configured for communication with the service client via a communication link.

28. The apparatus of claim 27 wherein the controller is further configures for consulting the access list to determine if the request is allowed, and if the request is allowed, then providing access for the requested resource.

29. The apparatus of claim 28 wherein:
the service client sends the request to an interface device in the network using a connection service access protocol;
the service manager further includes a protocol translator configured for providing a service access protocol translation; and
the controller is further configured for controlling access to the resource based on the access list by consulting the access list to determine if the request is allowed, and if the request is allowed, then causing the protocol translator to translate the request from the connection service access protocol to a local service access protocol for the requested resource.

30. The apparatus of claim 29 wherein the controller is further configured for sending the translated request to a device in the network for accessing the resource, using said local service access protocol.

31. The apparatus of claim 30 wherein the controller is further configured for receiving a response from the device for accessing the resource, and sending the response to a service client.

32. The apparatus of claim 31 wherein the controller is further configured for sending the response to the service client by causing the protocol translator to translate the response from the service access protocol of the device to the connection service access protocol of the service client before the controller sends the response to the service client via the interface and the communication link.

33. The apparatus of claim 28 wherein the controller is further configured for controlling access to the resource by consulting a centralized access list to determine if the request is allowed.

34. The apparatus of claim 28 wherein the request identifies a device capable of providing the resource, and the controller is further configured for controlling access to the resource by consulting a local access list in said device identified in the request in order to determine if the request is allowed.

35. The apparatus of claim 28 wherein the controller is further configured for controlling access to the resource if allowed by the access list, then generating a response to the request and filtering the response based on the access list.

36. The apparatus of claim 35 wherein the controller is further configured for filtering the response by selectively removing content from the response based on the access list.

37. The apparatus of claim 27 wherein the communication link comprises the Internet.

38. The apparatus of claim 23 wherein the service manager is configured for communication with the service client via a secured connection over the communication link.
